(19) United States
(12) Patent Application Publication
(10) Pub. No.: US 2009/0286208 A1
(43) Pub. Date: Nov. 19, 2009

(54) METHOD OF AND APPARATUS FOR VIRTUAL SHOOTING PRACTICE

(76) Inventor: Ronald F. Coleman, Carrollton, TX (US)

Correspondence Address: Klemchuk Kubasta llp, 8150 North Central Expressway, Suite 1150, DALLAS, TX, 75206, US

(21) Appl. No.: 12/497,867

(22) Filed: Jul. 6, 2009

Related U.S. Application Data
(63) Continuation of application No. 11/428,735, filed on Jul. 5, 2006.
(60) Provisional application No. 60/698,768, filed on Jul. 12, 2005.

(51) Int. Cl. F41G 3/26; A63F 13/04; A63F 9/02

(52) U.S. Cl. 434/20; 434/21; 463/5; 463/52

(57) ABSTRACT

A method of and apparatus for virtual shooting practice comprises a displayed shooting practice image including a target portion and a simulated gun. As the target portion of the image moves relative to the remainder thereof, the simulated gun is moved relative to the displayed image and relative to the moving target portion. Movement of the simulated gun is compared with the movement of the target portion of the displayed image resulting in a determination of whether a “shot” from the gun is a “hit” or a “miss”.

### CROSS-REFERENCE TO RELATED APPLICATIONS

This application is a continuation patent application of application Ser. No. 11/428,735 filed Jul. 5, 2006, currently pending, the entire contents of which are incorporated herein by reference; which claims priority based on provisional patent application Ser. No. 60/698,768 filed Jul. 12, 2005, the entire contents of which are incorporated herein by reference.

### TECHNICAL FIELD

This invention relates generally to a method of and apparatus for virtual shooting practice, and more particularly to a method of and apparatus for practicing bird shooting, artificial target shooting, and police and military combat shooting which does not require the actual discharge of firearms.

### BACKGROUND AND SUMMARY OF THE INVENTION

Like participants in all other sports, persons wishing to excel in the sport of bird shooting must practice between hunting activities. Long ago live birds, particularly pigeons, were used to simulate actual hunting situations. Due to the expense and inconvenience involved in gathering a sufficient number of live birds to facilitate worthwhile practice, artificial targets, commonly referred to as a “clay pigeons”, were substituted for live birds. Today, shooters frequently use facilitates known as skeet, trap, sporting clays, etc. to hone their bird shooting skills. Also, many shooters engage in skeet, trap, sporting clays, etc. as sports in and of themselves to the exclusion of actual bird shooting.

Regardless of whether artificial targets are utilized to practice for bird shooting or for targeting shooting competitions, finding a venue suitable for artificial target shooting can be problematic. Real or imagined problems such as danger to people and property from arrant projectiles, air and water pollution, noise pollution, etc. virtually rule out artificial target shooting in heavily populated urban areas. Parcels of land of sufficient size and suitable location to facilitate artificial target shooting activities are often prohibitably expensive even when located 100 miles or more from centers of urban areas. For these reasons fewer and fewer shooters are able to find artificial target shooting facilities that they can afford.

A similar circumstance presents itself to police and military personnel. Obviously, such individuals must practice on a continuous basis in order to be prepared when an armed combat situation arises. Because the handguns and long guns used in police and military combat have much longer ranges as compared with shotguns, projectile containment is an absolute necessity. This fact together with real or imagined concerns over air and water pollution and noise pollution virtually rule out police and military shooting practice in areas that are even remotely close to civilian populations.

In accordance with the broader aspects of the present invention simulated live bird targets, simulated artificial targets, and simulated police and military targets are generated electronically. Sportsmen and women, police personnel, and military personnel are provided with simulated weapons which are matched as closely as possible to the actual weapons that will be used in the field, on the range, or in combat situations. However, rather than discharging actual projectiles, the simulated weapons generate an electronic signal which interacts with the simulated target to score a “hit” or a “miss” depending upon how the simulated weapon is manipulated relative to the simulated target. An important feature of the invention comprises the fact that in the case of a “miss” the “shot” can be replayed thereby providing instant feedback as to why the “miss” occurred and the correction that is necessary in order to avoid another “miss”.

In accordance with more specific aspects of the invention virtual target practice activities utilizing the present invention may take place in full dome, half dome, or cylindrical practice arenas. Simulated live bird shooting is facilitated utilizing a full dome practice arena which allows simulated birds to “fly” from and toward all directions; at any and all conceivable angles and speeds; and in front of, over, or behind the individual that is trying to “shoot” them. Simulated artificial target sports can be successfully practiced in half dome arenas which are easily adapted to simulate actual skeet, trap, or and sporting clays ranges as well as the facilities utilized in other artificial target games. The cylindrical arena lends itself to practice by police and military personnel in that it simulates actual combat situations in which opponents utilize readily available objects for concealment and protection.

### BRIEF DESCRIPTION OF THE DRAWINGS

A more complete understanding of the present invention may be had by reference to the following Detailed Description when taken in connection with the accompanying Drawings, wherein:

FIG. 1 is a perspective view illustrating a first embodiment of the invention;

FIG. 1A is a break out of part of FIG. 1 illustrating a particular feature of the invention;

FIG. 2 is a perspective view illustrating a first version of a second embodiment of the invention;

FIG. 3 is a perspective view illustrating a second version of the second embodiment of the invention; and

FIG. 4 is a perspective view illustrating a third embodiment of the invention.

### DETAILED DESCRIPTION

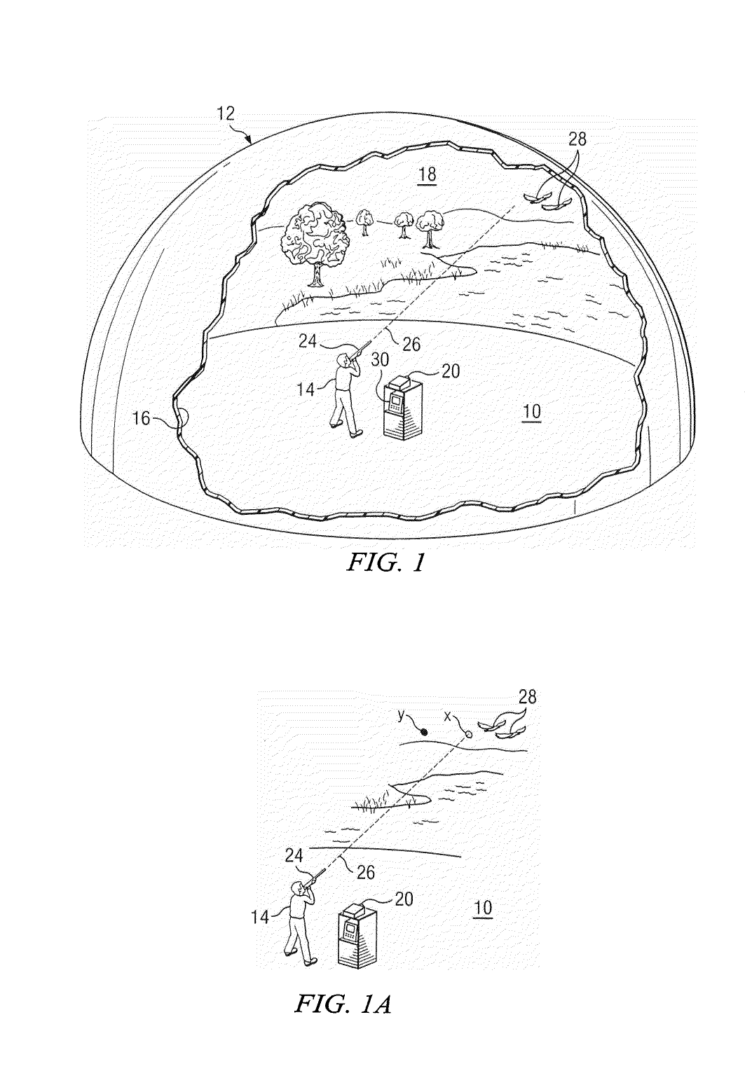

Referring now to the Drawings, and particularly to FIGS. 1 and 1A, there is shown a method of and an apparatus for virtual shooting practice incorporating a first embodiment of the invention. In accordance therewith a shooting practice venue 10 comprises a full dome 12 which completely encloses a shooter 14. That is, the full dome 12 extends entirely around and over the shooter 14.

The interior surface 16 of the dome 12 comprises a display service upon which a simulated hunting venue 18 is displayed. The simulated hunting venue 18 may be displayed on the interior surface 16 utilizing conventional display techniques of the type utilized in movie theaters, projection television systems, and the like. In such instances the display may emanate from one or more devices 20 situated within the dome 12. Alternatively, the venue 18 may comprise an LED display, a liquid crystal display, a plasma display, etc. utilizing well known technologies.

The shooter 14 is provided with a simulated shotgun 24 which is matched as closely as possible in weight and physical dimensions to the actual shotgun that the shooter 14 will use when hunting live birds. The simulated shotgun 24 does not discharge actual projectiles, but instead discharges an electronic beam 26 which interacts with the simulated hunting venue 18 displayed on the interior surface 16 of the full dome 12. Depending upon how the shooter 14 manipulates the simulated shotgun 24 relative to one or more “birds” 20 which “fly” across the interior surface 16 of the full dome 12, each “shot” made by the shooter 14 is calculated and recorded as a “hit” or as a “miss”.

An important feature of the invention is illustrated in FIG. 1A. In attempting to “kill” the “birds” 28 the shooter 14 moves the simulated shotgun 24 at a speed equal to or slightly greater than the simulated flight of the “birds” 28 across the simulated hunting venue 18 and in so doing established a lead relative to the “birds” 28 as indicated by the point X. However, in order to “kill” the “birds” 28, it was necessary for the shooter 14 to move the simulated shotgun 24 in such a manner as to establish a lead as indicated by the point Y. In accordance with the present invention any or all previous “shots” can be replayed together with a verbal or visual explanation of why the “miss” occurred, thereby allowing the shooter 14 to learn from the mistake and in so doing enhance his or her shooting skills.

Referring again to FIG. 1, the shooting practice venue 10 further includes a data input device 30 which can be used for a variety of purposes one of which is to allow the shooter 14 to select a particular simulated bird species that will be utilized in the simulated hunting venue 18. For example, the shooter 14 may select any of a variety of dove species, quail species, partridge species, ringneck or other pheasant species, any of a variety of duck species, geese species, etc. Depending upon the particular simulated bird species selected by the hunter 14, the images comprising remainder of the simulated hunting venue 18 will change dramatically. In this manner the hunter 14 is provided with a simulated hunting situation that is as realistic as possible. The data input device 30 may also be used to vary the simulated flight speed and the simulated flight path of the “birds” 28 as they “fly” across the venue 18.

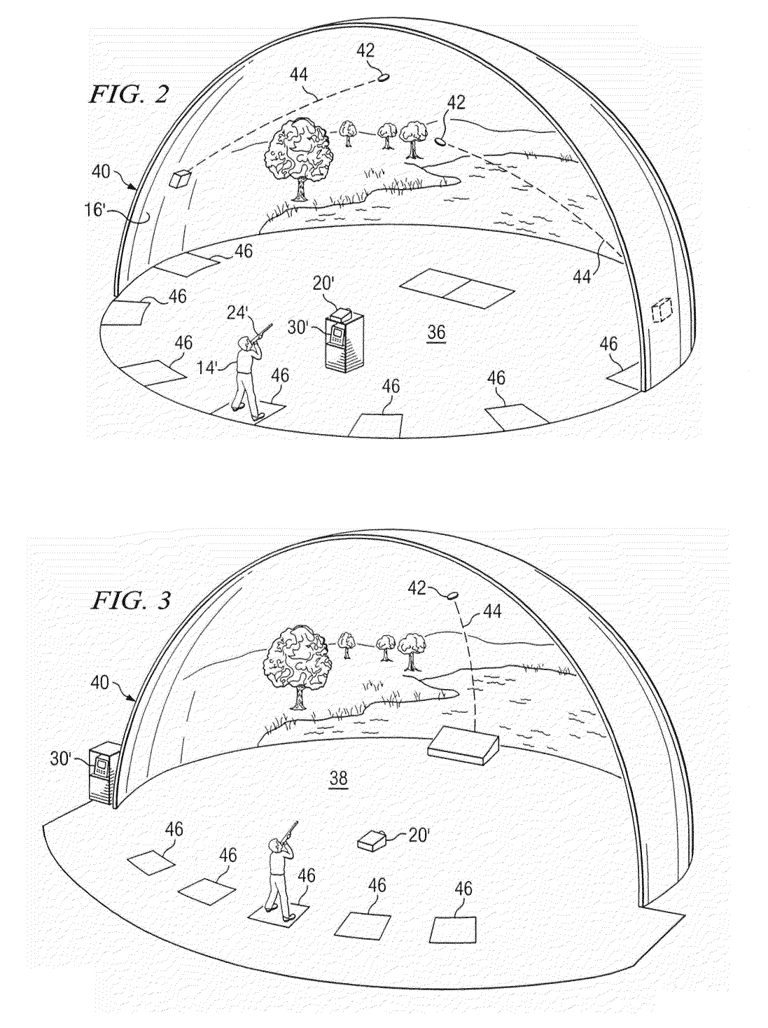

Referring to FIG. 2, there is shown a simulated skeet field or range comprising a first version of a second embodiment of the invention. FIG. 3 illustrates a simulated trap field or range 38 comprising a second version of the second embodiment of the invention. Many of the component parts of the simulated skeet field or range 36 and of the simulated trap field or range 38 are substantially identical in construction and function to component parts of the shooting practice venue 10 illustrated in FIG. 1 and described hereinabove in conjunction therewith. Such identical component parts are designated in FIGS. 2 and 3 with the same reference numerals utilized in the foregoing description of the shooting practice venue 10 but are differentiated therefrom by means of a prime (′) designation.

In lieu of the full dome 12 of the shooting practice venue 10 of FIG. 1, both the simulated skeet field or range 36 and the simulated trap field or range 38 utilize a half dome 40. As is well known to those skilled in the art, neither skeet nor trap employs targets which fly behind or above the shooter 14′. Therefore, a half dome is adequate for simulating the games of skeet and trap. However, other simulated artificial target games may require different dome configurations.

As is well known, when participating in artificial target games such as a skeet and trap, the shooter 14′ calls for a target by speaking the word “pull” or a similar word in a loud, clear voice. When participating in a simulated artificial target game incorporating the present invention, the shooter 14′ likewise calls for a target whereupon one or more simulated artificial targets 42 travel along flight paths 44 emulating the actual flight paths of real artificial targets. Movement of the simulated gun relative to the simulated artificial targets 42 is compared and calculated to determine whether the target has been “hit” or “missed”.

The shooter 14′ sequentially stands on a plurality of stations 46 which are dimensioned and positioned to match as closely as possible the shooting stations of actual artificial target shooting games. Likewise, scoring is identical to the scoring of the actual artificial target game that is being simulated with the only exception being that a “shot” can be replayed in order to provide positive feedback to the shooter 14′, thereby allowing the shooter to make corrections which will hopefully eliminate a “miss” on a subsequent “shot”.

The data input device 30′ may be employed to introduce variables into the play of the simulated artificial target shooting games comprising the second embodiment of the invention which are not possible in the play of actual artificial target shooting games. For example, in the case of novice shooters the data input device 30′ can be employed to cause the simulated artificial targets 42 to “fly” more slowly along the flight paths 44 than would be possible in the case of actual artificial targets. Conversely, in the case of experienced shooters the data input device 30′ can be used to randomly vary the period of time that elapses after the shooter 14′ calls for a target until the simulated artificial target is actually “released”, to randomly vary the speed at which the artificial targets “fly” along their respective flight paths, to randomly vary the angles of the flight paths, etc. None of these possibilities is available in the case of conventional artificial target shooting games utilizing real artificial targets.

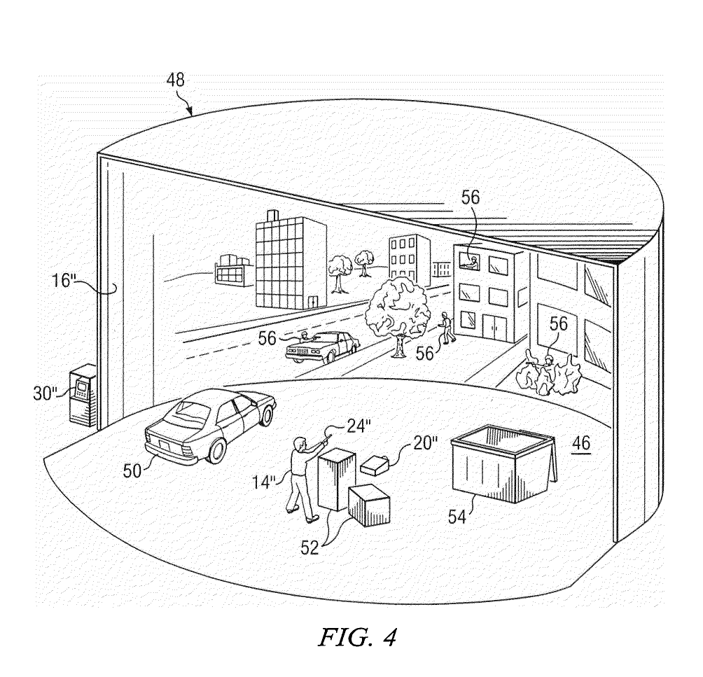

Referring to FIG. 3, there is shown a police/military combat practice venue 46 comprising a third embodiment of the invention. Many of the component parts of the police/military combat practice venue 46 are substantially identical to construction and function to component parts of the shooting practice venue 10 illustrated in FIG. 1 and described hereinabove in conjunction therewith. Such identical component parts are designated in FIG. 4 with the same reference numerals utilizing the foregoing description of the shooting practice venue 10 but are differentiated therefrom by means of a double prime (″) designation.

The police/military combat practice venue 46 is illustrated in FIG. 4 as comprising a semi-cylindrical enclosure 48. As will be appreciated by those skilled in the art, the police/military combat practice venue 46 may also comprise a full dome enclosure of the type illustrated in FIG. 1 or a half dome enclosure of the type illustrated in FIGS. 2 and 3. The use of a semi-cylindrical enclosure of the type illustrated in FIG. 4 is preferable in some instances because it allows the venue 46 to be incorporated into a conventional office building or warehouse.

The venue 46 differs from the venue 10 illustrated in FIG. 1 and described hereinabove in conjunction therewith in that the venue 46 employs a plurality of props such as a real or simulated automobile 50, one or more real or simulated containers 52, a real or simulated trash receptacle 54, etc. The purpose of incorporating one or more props into the venue 46 is to provide the shooter 14″ with a plurality of simulated concealment and protection opportunities.

The venue 46 further differs from the venue 10 of FIG. 1 in that rather than displaying one or more birds engaged in simulated flight or other movement across the display surface of the venue, the venue 46 displays a plurality of simulated human beings 56 some or all of which may be engaged in simulated combat with the shooter 14″ at any given time. Additionally, some or all of the simulated human beings 56 of the venue 46 may be engaged in simulated evasion and/or flight at any given time. In this manner the venue 46 simulates as closely as possible the real life combat situations which may be encountered by police and/or military personnel, and thereby allows police and military personnel utilizing the present invention to experience a very realistic practice session.

The data input device 30″ may be utilized to vary the particular combat practice scenario that is displayed on the interior surface 16″ of the cylindrical enclosure 48 comprising the venue 46. For example, the data input device 30″ may be used to display a jungle scenario, an arctic scenario, a robbery scenario, a terrorist scenario, a military scenario in which the human beings 56 are uniformed soldiers, etc. The data input device 30″ may also be used to vary the number of human beings 56 and the aggressiveness thereof dependent upon the skill level of the shooter 14″.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. A method of virtual shooting practice comprising the steps of:
providing a curvilinear display surface;
providing a shooting practice image including a target portion;
displaying the shooting practice image on the curvilinear display surface;
moving the target portion of the shooting practice image across the curvilinear display surface and relative to the remainder of the shooting practice image;
providing a human being desiring target practice;
providing a simulated gun for discharging an electronic signal;
the human being receiving and mounting the simulated gun;
the human being moving the simulated gun relative to the displayed shooting practice image and pursuant to movement of the target portion thereof,
the human being actuating the simulated gun to discharge the electronic signal therefrom;
comparing the movement of the simulated gun with the movement of the target portion of the shooting practice image; and
determining whether the human being has moved the simulated gun relative to the movement of the target portion of the shooting practice image in a manner indicative of the target portion being hit by the electronic signal discharged from the simulated gun.

2. The method of virtual shooting practice of claim 1, wherein the target portion of the shooting practice image is a simulated live bird target.

3. The method of virtual shooting practice of claim 1, wherein the target portion of the shooting practice image is a simulated artificial target.

4. The method of virtual shooting practice of claim 1, wherein the target portion of the shooting practice image is a simulated police target.

5. The method of virtual shooting practice of claim 1, wherein the target portion of the shooting practice image is a simulated military target.

6. The method of virtual shooting practice of claim 1, wherein a simulated hunting environment is displayed on the display surface.

7. The method of virtual shooting practice of claim 1, wherein a simulated artificial target shooting environment is displayed on the display surface.

8. The method of virtual shooting practice of claim 1, wherein a simulated police scenario is displayed on the display surface.

9. The method of virtual shooting practice of claim 1, wherein a simulated military scenario is displayed on the display surface.

10. The method according to claim 1, wherein the curvilinear display surface is a hemisphere.

11. The method according to claim 1, wherein the curvilinear display surface is a half hemisphere.

12. The method according to claim 1, wherein the curvilinear display surface is a half cylinder.
